(19) United States
(12) Patent Application Publication
(10) Pub. No.: US 2020/0178728 A1
(43) Pub. Date: Jun. 11, 2020

(54) Selectively Closable Hatch

(71) Applicant: Premier Specialty Brands LLC, Duluth, GA (US)

(72) Inventor: Robert Brennan, Duluth, GA (US)

(73) Assignee: Premier Specialty Brands LLC, Duluth, GA (US)

(21) Appl. No.: 16/704,112

(22) Filed: Dec. 5, 2019

Related U.S. Application Data
(60) Provisional application No. 62/776,532, filed on Dec. 7, 2018.

(51) Int. Cl. A47J 37/07; F24B 5/02; F23B 30/00

(52) U.S. Cl. CPC A47J 37/0754; F23B 2700/013; F23B 7/002; F24B 5/026

(57) ABSTRACT

Embodiments of the present disclosure relate to a selectively-closable hatch for automatically preventing airflow through the blower inlet of a fuel-burning grill. The hatch has a first, normal, resting closed configuration which prevents the flow of air through the inlet and into the cooking chamber of the grill, and a second, open configuration which is obtained when a fan is engaged to create a forceful airflow through the inlet path. The force of air pushed against the hatch pushes the hatch open, both when the fan is disengaged or falls below a minimum strength, the hatch returns to the closed configuration and prevents air from being drawn or otherwise flowing through the inlet path into the cooking chamber of the grill.

### CROSS-REFERENCE TO RELATED APPLICATIONS

This application titled “Selectively Closable Hatch” is a non-provisional application claiming the benefit to Provisional Application No. 62/776,532 filed Dec. 7, 2018 and titled “Selectively Closable Hatch,” which is hereby incorporated by reference in its entirety as if set forth below.

### TECHNICAL FIELD

The present disclosure relates to a method and device for improving temperature control within a grill. Specifically, embodiments of the present disclosure relate to a selectively closable hatch for preventing the unwanted draw of oxygenated air into the base of the grill except when such airflow is desired. By preventing the inlet from continuously allowing air to be drawn into the cooking chamber of a grill, the user can more precisely control the temperature at which the interior of the cooking chamber is held.

### BACKGROUND

It is known that the temperature within the cooking chamber of a fuel-burning device (referred to herein as a “grill”) can be adjusted or controlled by positioning a fan adjacent to or within an inlet in the grill base. The fan, when engaged, pushes oxygen-containing air into the cooking chamber near the fuel. The greater the oxygen supply to the burning fuel, the more vigorously the fuel will burn, resulting in increased fire intensity and thus an increased temperature within the cooking chamber.

To assist with temperature control, a plurality of closable louvers may be interposed in the path of the airflow through the inlet and into the grill. Such louvers may be mechanically opened and closed or positioned to be partially opened or partially closed to increase or decrease the airflow through the inlet or prevent it entirely. Currently, due to cost concerns, most grill louvers are typically manually closable or adjustable. Therefore, if the blower fan is to function properly, the louvers of the inlet must be positioned to be at least partially open so that air blown by the fan can move through the inlet and into the cooking chamber.

Conversely, if the fan is not running and the openings are even partially open, air may still move between the blades of the fan through the inlet and into the cooking chamber. If the fuel is burning, air will be actively drawn through this open path and into the grill. Apart from manually closing the louvers or openings of the path of airflow, there has not been a way to automatically prevent air from being drawn through the fan and inlet. Additionally, grill users are reluctant to reach near the hot grill to close the inlet by hand. Therefore, it is not uncommon for the airflow to continue through the fan and into the cooking chamber even when the fan is turned off and the user desires the internal temperature to remain the same.

The presently disclosed embodiments are directed to these and other objectives.

### SUMMARY

Embodiments of the present disclosure include a selectively closable hatch for a fuel-burning grill. The presently disclosed embodiments attempt to solve the above-mentioned problems by utilizing a hatch located in the inlet path, the hatch being biased closed and configured to open when the fan is engaged and reaches a certain speed. The biased-closed hatch is positioned in the path of airflow, the path being from outside the grill through the fan and into the grill through the grill inlet. When the fan is not engaged to move air, the hatch can be in a closed configuration, which will prevent the undesirable flow of oxygenated air through the inlet path.

In some embodiments, the fan may be a blower fan. The typical blower fan utilized in fuel-burning grills is relatively weak, being capable of a maximum air throughput of ten ft³/minute (approximately 0.3 m³/minute). This sized fan results in very weak airflow into the cooking chamber of the grill (e.g., more of a puff than a steady breeze). In some embodiments, the strength of airflow into the grill can be increased by utilizing a more powerful blower fan or restricting the size of the inlet into the cooking chamber. For instance, in some embodiments a variable speed fan with a maximum speed of up to 30 ft³/minute (approximately 0.9 m³/minute) may be used. In embodiments where the inlet is approximately circular in shape, the size can be decreased by reducing the diameter of the inlet.

By increasing the strength of this airflow, the air may be made powerful enough to open the hatch positioned across the inlet and allow the air to flow through the inlet. However, when the airflow created by the fan is turned off or made so low as to lose sufficient strength, the hatch closes thereby preventing the airflow through the inlet without manually or mechanically closing or otherwise obstructing the inlet.

### BRIEF DESCRIPTION OF THE DRAWINGS

FIG. 1 illustrates a selectively closable hatch, according to some embodiments of the present disclosure.

FIG. 2A illustrates a selectively closable hatch in a closed state and attached to a temperature adjustment unit, according to some embodiments of the present disclosure.

FIG. 2B illustrates a selectively closable hatch in an open state and attached to a temperature adjustment unit, according to some embodiments of the present disclosure.

FIG. 3 illustrates a temperature adjustment unit attached to the side of a fuel-burning grill, according to some embodiments of the present disclosure.

### DETAILED DESCRIPTION

Typical fuel-burning grills, such as kamado-style grills, have an inlet proximate the base of the grill through which air can enter and vent. The amount of air entry permitted is useful in adjusting and controlling the temperature within the cooking chamber of the grill. For instance, if it is desired to increase the temperature within the cooking chamber, air can be introduced to the inlet which rises through the cooking chamber, interacts with the fuel within the grill, and causes the fuel to burn more rapidly. Otherwise, if it is desired to maintain or control the temperature within the cooking chamber, air contact with the fuel can be decreased and held constant. Generally, air is introduced to the interior of the grill through a controlled inlet that can be increased and decreased in size as needed.

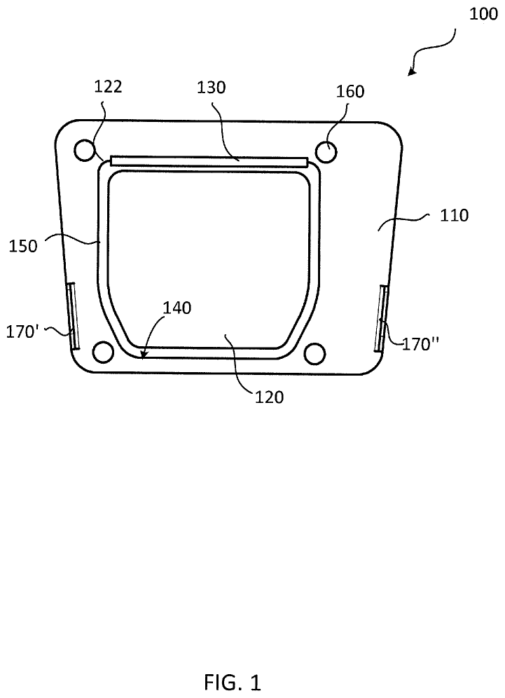

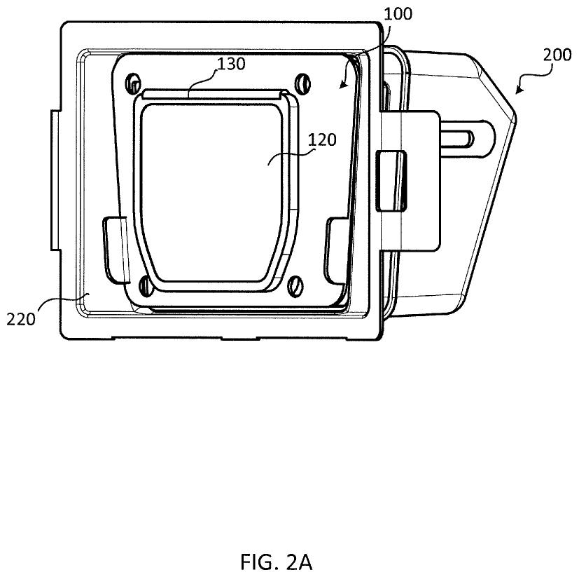

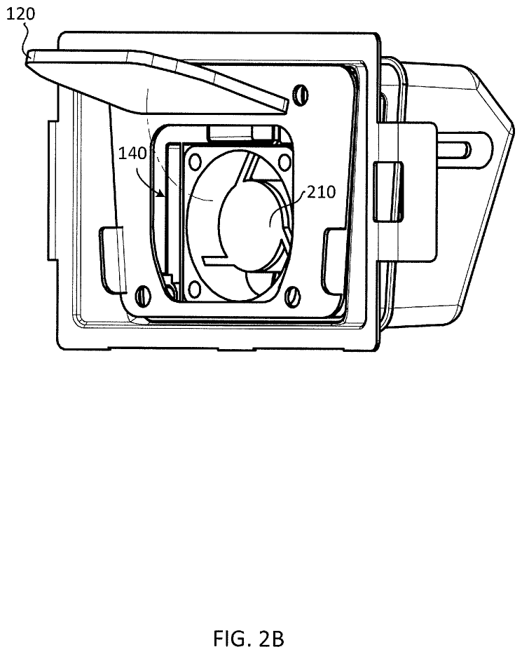

FIG. 1 illustrates an embodiment of a selectively closable hatch 100, according to some embodiments of the present disclosure. The selectively closable hatch is an accessory for a temperature adjustment unit 200, such as that illustrated in FIGS. 2A and 2B, to provide variable temperature control as needed while cooking using a fuel-burning grill.

As illustrated in FIG. 1, the selectively closable hatch (also referred to herein as a hatch) can comprise a plate 110 including a passage 140 and a door 120 connected to the plate 110 via a hinge 130. The door 120 and passage 140 of the hatch 100 can be disposed proximate a center-most portion of the plate 110. The plate 110 can be substantially rectangular in shape and comprise holes 160 proximate the four corners for securing the plate 110 to a temperature adjustment unit 200, as illustrated in FIGS. 2A and 2B. The plate 110 can further comprise tabs 170′, 170″ on either side of a bottom portion of the plate 110 for assisting with removing the plate when desired.

The door 120 and corresponding passage 140 of the selectively closable hatch 100 can be substantially U-shaped, with the hinge 130 attached about a top edge 122 of the door 120. The selectively closable hatch 100 can comprise a seal 150 disposed around a perimeter of the door 120. In some embodiments, the seal 150 can be a flame value, silicone seal such that it is flame resistant to withstand the hot temperatures of the fuel-burning grill.

FIGS. 2A and 2B illustrate a selectively closable hatch 100 attached to a temperature adjustment unit 200 in an closed state and an open state, respectively. Generally, the hatch 100 is in a closed state, as illustrated in FIG. 2A, in which the door 120 substantially blocks the passage 140. When the fan 210 is propelling air at a sufficient speed, the hatch 100 can swing open to an open state, as illustrated in FIG. 2B, such that airflow can be achieved through the grill inlet and into the cooking chamber. For instance, the door 120 can swing upwards via the hinge 130, as illustrated in FIG. 2B.

The hatch 100 can move from a closed configuration to an open configuration when the fan unit 210 behind reaches a certain speed, as illustrated in FIGS. 2A and 2B. For instance, in some embodiments, the hatch 100 may be blown open when the fan 210 is operating at a speed of between about 10 ft³/minute and about 30 ft³/minute. In some embodiments, the fan 210 may be operating at 5 ft³/minute, 10 ft³/minute, 15 ft³/minute, 20 ft³/minute, 25 ft³/minute, or 30 ft³/minute. In other embodiments the fan 210 may be operating at from about 0 ft³/minute to about 5 ft³/minute, from about 5 ft³/minute to about 10 ft³/minute, from about 10 ft³/minute to about 15 ft³/minute, from about 15 ft³/minute to about 20 ft³/minute, from about 20 ft³/minute to about 25 ft³/minute, or from about 25 ft³/minute to about 30 ft³/minute. The speed of the fan 210 may be greater than 30 ft³/minute depending on the strength of the fan and the hatch 100 will remain open. When airflow into the inlet is not desired, such as in a situation where it is desirable to maintain or decrease the temperature in the cooking chamber, the hatch 100 can be in a closed configuration, as illustrated at FIG. 2A, and block entry of unwanted air. Additionally, the hatch 100 may be configured to close when the fan 210 is operating at a speed less than that required to open the hatch 100. For instance, in some embodiments, the hatch 100 may be configured to close when the speed of the fan 210 is less than about 10 ft³/minute or less than about 5 ft³/minute.

The embodiments shown in FIGS. 2A-2B comprise a temperature adjustment unit 200 to which the hatch 100 is attached. In some embodiments, when used in conjunction with the temperature adjustment unit 200, the selectively closable hatch 100 can be attached proximate a back 220 side of the temperature adjustment unit 200 such that the hatch 100 is disposed above or in front of the fan unit 210, so as to block the fan unit 210 (shown in FIGS. 2A and 2B). In some embodiments, the hatch 100 can be fixed to the temperature adjustment unit 200 via screws through the holes 160 positioned proximate the four corners of the plate. Each screw can couple with a corresponding hole disposed within the temperature adjustment unit 200 thereby securing the hatch 100 to the temperature adjustment unit 200.

It is understood that while the embodiments of the hatch 100 are described with reference to a temperature adjustment unit 200 as depicted in FIGS. 2A and 2B, other hatch configurations are contemplated.

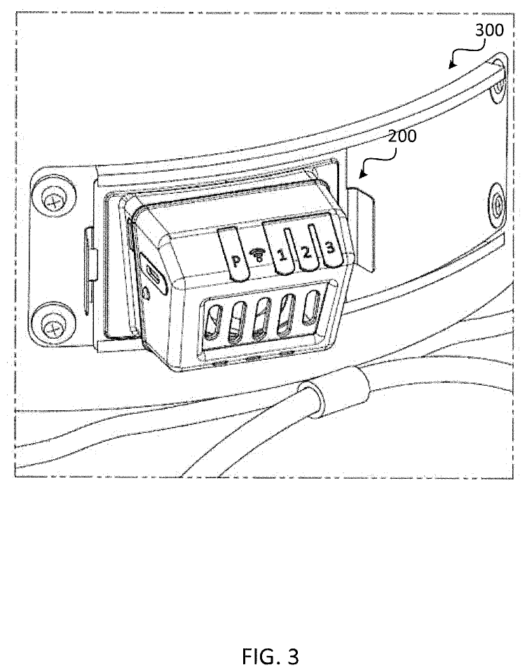

When the temperature adjustment unit 200 is used in connection with a fuel-burning grill 300, the temperature adjustment unit 200 may be disposed proximate an inlet (not shown) of the fuel-burning grill 300, as illustrated in FIG. 3. In some embodiments, the hatch (not seen in FIG. 3) can be disposed on a portion of the temperature adjustment unit 200 to be placed proximate the inlet of the fuel-burning grill 300. In some embodiments, the surface on which the hatch is disposed can be slightly curved so as to fit snuggly against an external surface of the fuel-burning grill 300. The inlet can be disposed proximate the grill base and through which external air may be drawn into the cooking chamber such that the external air will rise, following a path from the inlet, to the fuel, and through the cooking chamber, exiting near a top portion of the fuel-burning grill 300.

When the fan 210 is not blowing air at a sufficient speed to cause the door 120 of the hatch 100 to open, the hatch 100 is biased closed (as seen in FIG. 2A) such that the hatch 100 substantially prevents airflow through the grill inlet and into the cooking chamber. In some embodiments, the hatch 100 can be biased into the closed configuration by gravity. In other embodiments, the hatch 100 can be biased into the closed configuration by a spring-loaded closure.

The fan 210 may be used to maintain a desired temperature within the cooking chamber. In some embodiments, the fan 210 may be remotely controlled, such as through an app on a mobile device. For instance, based on temperature readings within the cooking chamber, the application can be used to selectively turn the fan 210 on and off to increase or decrease the flow of oxygen into the cooking chamber.

In some embodiments, the fan 210 may be selectively engaged (i.e. turned on and off) to maintain and control the desired temperature within the cooking chamber. Once the cooking chamber reaches the desired temperature, the fan 210 may be turned off and turned on as needed to maintain or adjust the temperature within the cooking chamber.

In other embodiments, the fan 210 may be a variable speed fan. Using a variable speed fan, it would be desirable for the minimum speed of the fan 210 to be sufficient to actuate the hatch 100 into the open position, thereby allowing the full range of speeds of the variable speed fan to be taken advantage of.

Alternative means for automatically preventing airflow through the inlet when the fan is not engaged also fall within the concept of this disclosure. Other embodiments may comprise a lightweight gasket of a material configured to be pushed open by the force of the air pushed by a fan yet not being in the form of a hatch. For example, embodiments of the present disclosure may comprise a closure for the circular opening having a series of slits. In some embodiments, the series of slits may be cut in a star pattern which are pushed opened by a flow of air, yet returned to a normal position substantially eliminating the flow of air when the flow of air falls below a certain strength. Other closure means are also possible, and fall within the scope of the present disclosure, the only requirement being that a closure means have a first normal closed configuration but capable of being actuated into a second opened configuration by a sufficiently strong flow of air against one side of it. In the present invention, a maximum flow of air may be required to actuate the closure means to the second, opened position. A flow of air against the exterior surface of the closure around approximately normal air movement caused by typical breezes about the grill would not open the closure means.

1. A selectively-closable hatch for a temperature adjustment unit comprising a fan unit for a fuel-burning grill, the selectively closable hatch comprising:
a plate including a passage; and
a door hingeably connected to the plate about a top edge of the door;
wherein when the selectively-closable hatch is in a closed position, the door is configured to block the passage; and
wherein when the selectively-closable hatch is in an open position, the door is configured to expose the passage.

2. The selectively-closable hatch of claim 1, further comprising a seal disposed around the perimeter of the door.

3. The selectively-closable hatch of claim 1, wherein the door is configured to hinge upward when the fan is operating at a speed of between about 10 ft³/min to about 30 ft³/min.

4. The selectively-closable hatch of claim 1, wherein the door comprises a hinge member disposed on an upper edge of the door and connecting the door to the plate, by which the door can hinge upward.

5. The selectively-closable hatch of claim 1, wherein the door is substantially u-shaped.

6. The selectively-closable hatch of claim 1, wherein the plate is removably attached to a back side of the temperature adjustment unit.

7. A temperature adjustment unit comprising:
a fan unit;
a selectively closable hatch, disposed in front of the fan unit, the selectively closable hatch comprising a door hingeably connected to a plate;
wherein upon exposure to the door by a stream of air from the fan unit, the door is configured to hinge upward to allow air to move from the passage and into the fuel-burning grill.

8. The selectively-closable hatch of claim 7, further comprising a seal disposed around the perimeter of the door.

9. The selectively-closable hatch of claim 7, wherein the door is configured to hinge upward when the fan is operating at a speed of from about 10 ft³/min to about 30 ft³/min.

10. The selectively-closable hatch of claim 7, wherein the door comprises a hinge member disposed on an upper edge of the door and connecting the door to the plate, by which the door can hinge upward.

11. The selectively-closable hatch of claim 7, wherein the door is substantially u-shaped.

12. The selectively-closable hatch of claim 7, wherein the plate is removably attached to a back side of the temperature adjustment unit.

13. A method for variable temperature control comprising:
attaching a temperature adjustment unit about an inlet of a fuel-burning grill, the temperature adjustment unit comprising a fan and a hatch disposed in front of the fan unit;
causing the fan to blow a stream of air towards the hatch;
opening the hatch when the stream of air reaches a speed of from about 10 ft³/min, to provide the stream of air to the inlet;
determining that an internal temperature of the fuel-burning grill is a first temperature;
causing the fan to stop blowing the stream of air towards the hatch; and
closing the hatch when the stream of air reaches a speed of less than about 10 ft³/min.
